(19) United States
(12) Patent Application Publication
(10) Pub. No.: US 2012/0274588 A1
(43) Pub. Date: Nov. 1, 2012

(54) PORTABLE ELECTRONIC APPARATUS, CONTROL METHOD, AND STORAGE MEDIUM STORING CONTROL PROGRAM

(75) Inventor: Hiroyuki BAMBA, Yokohama-shi (JP)

(73) Assignee: KYOCERA CORPORATION, Kyoto (JP)

(21) Appl. No.: 13/455,444

(22) Filed: Apr. 25, 2012

(30) Foreign Application Priority Data
Apr. 26, 2011 (JP) 2011-098634

(51) Int. Cl. G06F 3/041

(52) U.S. Cl. 345/173

(57) ABSTRACT

According to aspect, a portable electronic apparatus includes a first display unit, a first operation detecting unit, a second display unit, a second operation detecting unit, and a control unit. The first and second display units display first and second screens, respectively. The first and second operation detecting units detect an operation for the first and second screens, respectively. When a period of time in which an operation for at least one of the first and second screens is not detected is longer than a threshold value, the control unit performs a power saving process. In the power saving process, the control unit changes a state of at least one of the first and second display units to a power-saving state in a varied manner depending on a type of program providing the screen for which no operation is detected for a longer period of time than the threshold value.

### CROSS-REFERENCE TO RELATED APPLICATIONS

This application claims priority from Japanese Application No. 2011-098634, filed on Apr. 26, 2011, the content of which is incorporated by reference herein in its entirety.

### BACKGROUND

1. Technical Field

The present disclosure relates to a portable electronic apparatus, a control method, and a storage medium storing therein a control program.

2. Description of the Related Art

As a technique of reducing the power consumption of a portable electronic apparatus, there is a known technique of suppressing the power consumption of a display unit by lighting no display when an operation is not performed for a predetermined period of time (for example, Japanese Patent Application Laid-Open No. 2004-320107). Further, there is a known portable electronic apparatus that includes a plurality of display units to provide a broader display unit to a user (for example, Japanese Patent Application Laid-Open No. 2009-164794).

A portable electronic apparatus including a plurality of display units can be utilized in various use forms, such as, a form in which only one of the display units is used, a form in which the display units are used for different purposes respectively, and in a form in which the display units can are used as a combined display unit. However, the above-mentioned technique of suppressing the power consumption, that is thought of on the assumption that the portable electronic apparatus includes a single display unit, may not realize a power saving process suitably in accordance with the various use forms.

For the foregoing reasons, there is a need for a portable electronic apparatus, a control method, and a control program that can realize the power saving process suitably in accordance with the use conditions.

### SUMMARY

According to aspect, a portable electronic apparatus includes a first display unit, a first operation detecting unit, a second display unit, a second operation detecting unit, and a control unit. The first display unit displays a first screen. The first operation detecting unit detects an operation for the first screen displayed on the first display unit. The second display unit displays a second screen. The second operation detecting unit detects an operation for the second screen displayed on the second display unit. When a period of time in which an operation for at least one of the first and second screens is not detected is longer than a threshold value, the control unit performs a power saving process. In the power saving process, the control unit changes a state of at least one of the first and second display units to a power-saving state in a varied manner depending on a type of program providing the screen for which no operation is detected for a longer period of time than the threshold value.

According to another aspect, a control method is executed by a portable electronic apparatus including a first display unit, a second display unit, and an operation detecting unit. The control method includes: displaying a first screen on the first display unit; displaying a second screen on the second display unit; detecting an operation for a first or second screen by the operation detecting unit; determining whether a non-operation time in which an operation for at least one of the first and second screens is not detected is longer than a threshold value; and changing, when the non-operation time is longer than the threshold value, a state of at least one of the first and second display units to a power-saving state in a varied manner depending on a type of a program providing the screen for which the non-operation time is longer than the threshold value.

According to another aspect, non-transitory storage medium stores a control program. When executed by a portable electronic apparatus that includes a first display unit, a second display unit, and an operation detecting unit, the control program causes the portable electronic apparatus to execute: displaying a first screen on the first display unit; displaying a second screen on the second display unit; detecting an operation for a first or second screen by the operation detecting unit; determining whether a non-operation time in which an operation for at least one of the first and second screens is not detected is longer than a threshold value; and changing, when the non-operation time is longer than the threshold value, a state of at least one of the first and second display units to a power-saving state in a varied manner depending on a type of a program providing the screen for which the non-operation time is longer than the threshold value.

### BRIEF DESCRIPTION OF THE DRAWINGS

FIG. 1 is a front view of a mobile phone in an open form;

FIG. 2 is a side view of the mobile phone in the open form;

FIG. 3 is a block diagram of the mobile phone;

FIG. 4 is a diagram illustrating an example of program information;

FIG. 5 is a diagram illustrating an example of control when two programs are separately activated;

FIG. 6 is a diagram illustrating another example of control when two programs are separately activated;

FIG. 7 is a diagram illustrating an example of control when a two-screen program is used;

FIG. 8 is a diagram illustrating another example of control when a two-screen program is used;

FIG. 9 is a diagram illustrating an example of control when another program is called from a program;

FIG. 10 is a flowchart illustrating a processing sequence of a power-saving proceeding process; and

FIG. 11 is a flowchart illustrating a processing sequence of a power-saving returning process.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the portable electronic apparatus; however, the present invention is not limited to mobile phones. Therefore, the present invention can be applied to any type of devices provided with a touch panel, including but not limited to personal handyphone systems (PHS), personal digital assistants (PDA), portable navigation units, personal computers (including but not limited to tablet computers, netbooks etc.), media players, portable electronic reading devices, and gaming devices.

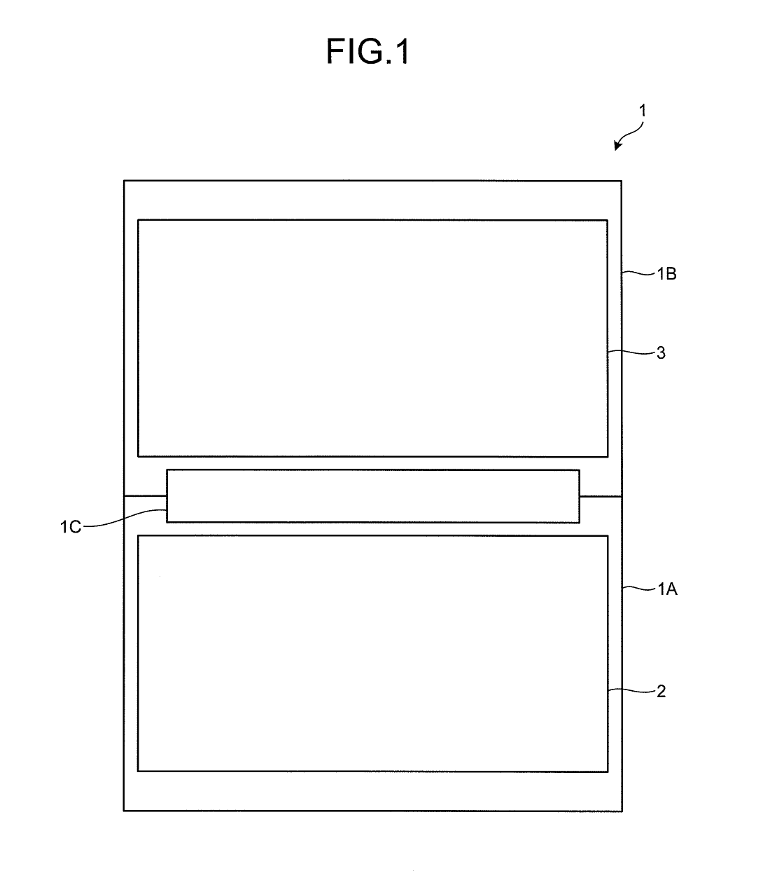

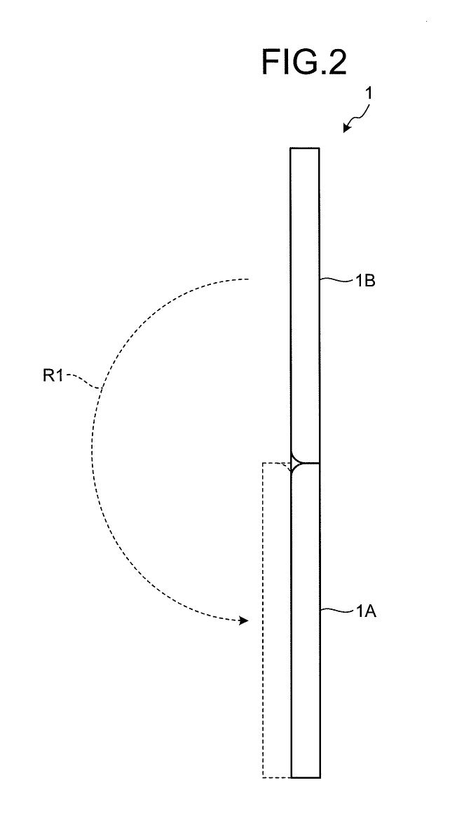

First of all, an overall configuration of a mobile phone 1 according to a first embodiment of the portable electronic apparatus will be described with reference to FIGS. 1 and 2. FIG. 1 is a front view of the mobile phone 1 in an open form. FIG. 2 is a side view of the mobile phone 1 in the open form. As illustrated in FIGS. 1 and 2, the mobile phone 1 includes a first housing 1A, a second housing 1B, and a connection unit 10. The first housing 1A includes a touch panel 2. The second housing 1B includes a touch panel 3.

The touch panel 2 is provided in one of the broadest surfaces of the first housing 1A, and displays characters, figures, and images. Further, the touch panel 2 detects various operations performed on the surface of the touch panel 2 with a finger, a stylus, a pen, or the like (in the description herein below, for the sake of simplicity, it is assumed that the user touches the touch panel with his/her finger(s)). The touch panel 3 is provided in one of the broadest surfaces of the second housing 1B, and displays characters, figures, and images. Further, the touch panel 3 detects various operations performed on the surface of the touch panel 3 with the finger. The touch panels 2 and 3 may detect various operations using any detection method, such as a capacitive type detection method, a resistive type detection method, and a pressure-sensitive type detection method.

The connection unit 10 connects the first housing 1A to the second housing 1B and serves as a rotational axis at which the first housing 1A and the second housing 1B rotate relatively. The form of the mobile phone 1 is changed from an open form to a closed form, when the second housing 1B rotates in a direction R1 illustrated in FIG. 2 by about 180 degrees about the connection unit 10 serving as the rotation axis.

When the mobile phone 1 is in the open form, as in FIGS. 1 and 2, the touch panels 2 and 3 are is exposed in the state where they are oriented substantially in the same direction. In the open form, the mobile phone 1 displays different screens on the touch panels 2 and 3 respectively, or displays one screen over the touch panels 2 and 3. The mobile phone 1 realizes power-saving by changing a manner of controlling the touch panels 2 and 3 in accordance with a use status. The control of the touch panels 2 and 3 in the open form will be described in detail later.

When the mobile phone 1 is in the closed form, the touch panels 2 and 3 face each other, and thus are not seen from the outside. In the closed form, the mobile phone 1 stops the functions of the touch panels 2 and 3. That is, the mobile phone 1 reduces the power consumption by stopping a function as a display unit and a function as an operation unit of the touch panels 2 and 3.

As described above, the mobile phone 1 includes so-called folding-type housings. However, the mobile phone 1 may include sliding-type housings. That is, in a closed form where the overlapping areas of the two housings are the maximum, only the touch panel of one housing may be exposed in the mobile phone 1. In an open form where the overlapping areas of the two housings are the minimum, the touch panels of both housings may be exposed.

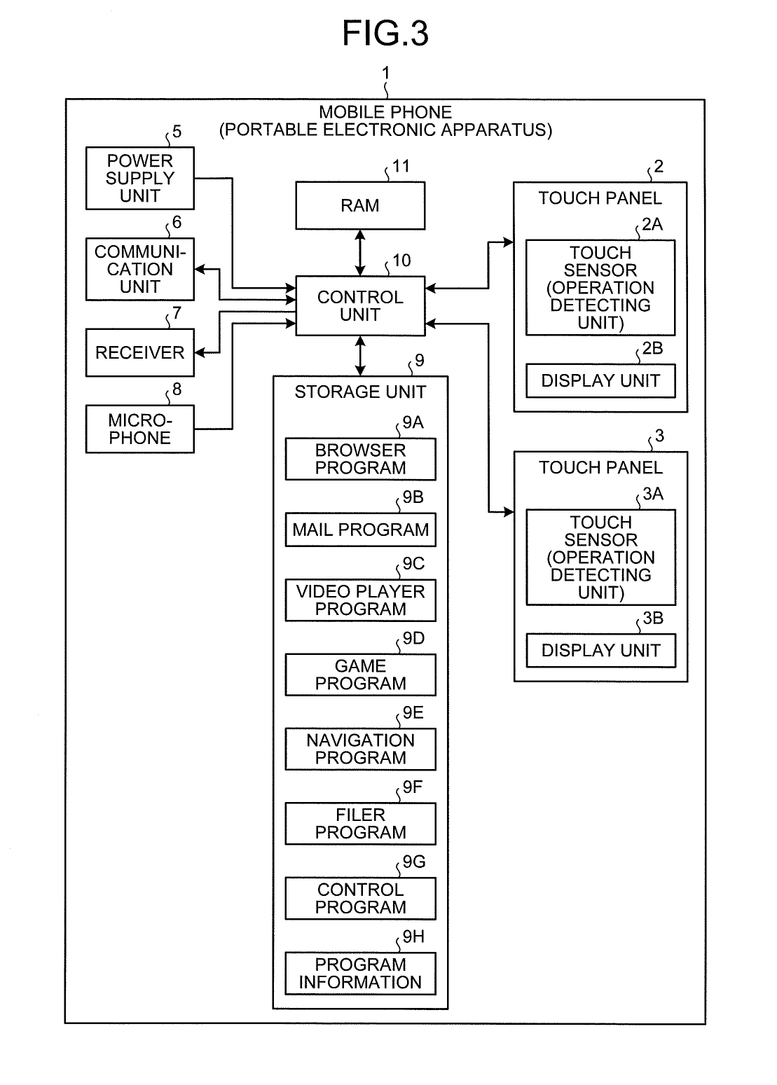

Then, the functional configuration of the mobile phone 1 will be described with reference to FIG. 3. FIG. 3 is a block diagram of the mobile phone 1. As illustrated in FIG. 3, the mobile phone 1 includes the touch panel 2, the touch panel 3, a power supply unit 5, a communication unit 6, a speaker 7, a microphone 8, a storage unit 9, a control unit 10, and a RAM (Random Access Memory) 11. The constituent units may be provided in either one of the first housing 1A and the second housing 1B, excluding the touch panel 2 and the touch panel 3 provided in the first housing 1A and the second housing 1B respectively.

The touch panel 2 includes a display unit 2B and a touch sensor (operation detecting unit) 2A superimposed on the display unit 2B. The touch sensor 2A detects various operations performed on the surface of the touch panel 2 with finger(s) as well as a position at which an operation is performed on the touch panel 2, and notifies the control unit 10 of the detection result. Examples of the operation detected by the touch sensor 2A include a tap operation and a sweep (swipe) operation. The display unit 2B is formed with a LCD (Liquid Crystal Display), an OELD (Organic Electro-Luminescence Display), or the like, and displays characters, figures, or the like.

The touch panel 3 includes a display unit 3B and a touch sensor (operation detecting unit) 3A superimposed on the display unit 3B. The touch sensor 3A detects various operations performed on the surface of the touch panel 3 with finger(s) as well as a position at which an operation is performed on the touch panel 3, and notifies the control unit 10 of the detection result. Examples of the operation detected by the touch sensor 3A include a tap operation and a sweep operation. The display unit 3B is formed a LCD, an OELD, or the like, and displays characters, figures, or the like.

The power supply unit 5 supplies power obtained from a battery or an external power supply to each functional unit of the mobile phone 1 including the control unit 10. The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The speaker 7 outputs a sound signal transmitted from the control unit 10 as a sound. The microphone 8 converts the voice of a user or the like into a sound signal and transmits the sound signal to the control unit 10.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.). The storage unit 9 stores programs or data used for processes in the control unit 10. Examples of the programs stored in the storage unit 9 include a browser program 9A, a mail program 9B, a video player program 9C, a game program 9D, a navigation program 9E, a filer program 9F, and a control program 9G. Examples of the data stored in the storage unit 9 include program information 9H. The storage unit 9 further stores various programs such as an operating system program for implementing the basic functions of the mobile phone 1 and various kinds of data such as address book data. The storage unit 9 may be constituted of a combination of a portable storage medium, such as a memory card and optical disc, and a reading device of the storage medium.

The browser program 9A provides a WEB browsing function. The mail program 9B provides an e-mail function. The video player program 9C provides a function of reproducing video data. The game program 9D provides a game function. The navigation program 9E provides a function of guiding a user to a certain place. The filer program 9F provides a function of accessing various files (including programs and data) stored in the storage unit.

The control program 9G provides a function of controlling the operation of each unit of the mobile phone 1 depending on the detection results of various detecting units. For example, the control program 9G provides a function of performing control to suppress the power consumption of the touch panels 2 and 3 in accordance with the use status of the touch panels 2 and 3.

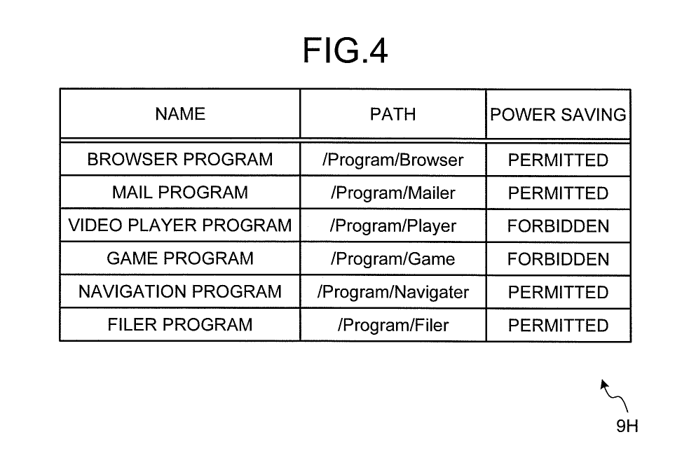

The program information 9H retains information regarding various programs activated in response to an instruction from the user. An example of the program information 9H is illustrated in FIG. 4. As illustrated in FIG. 4, the program information 9H includes items, such as Name, Path, and Power-saving. Stored under the item Name is a name of a program. Stored under the item Path is a value that indicates a location at which the program is stored. Stored under the item Power-saving is a value that indicates whether shift to the power-saving state is permitted during the execution of the program. When the shift to the power-saving state is permitted during the execution of the program, “PERMITTED” is set in the power saving. When the shift to the power-saving state is not permitted during the execution of a program, “FORBIDDEN” is set in the power saving.

In this embodiment, it is assumed that the shift to the power-saving state is not permitted during the execution of the video player program 9C and the game program 9D as represented in the example of the program information 9H in FIG. 4. Further, it is assumed that the shift to the power-saving state is permitted during the execution of the browser program 9A, the mail program 9B, the navigation program 9E, and the filer program 9F.

Whether the shift to the power-saving state is permitted or not during the execution of the program may be set in advance for each program or may be set arbitrarily by a user. Further, information regarding whether the shift to the power-saving state is permitted or not during the execution of the program may not be managed in the program information 9H, but may be embedded in each program.

The control unit 10 is a processing unit such as a CPU (Central Processing Unit). The control unit 10 realizes various functions by integrally controlling the operation of the mobile phone 1. Specifically, the control unit 10 executes commands included in a program stored in the storage unit 9 with reference to the data stored in the storage unit 9 or the detection results of various detecting units, as necessary, and controls the touch panel 2, the communication unit 6, and the like. The program executed by the control unit 10 or the data referred to in the execution may be downloaded from a server through communication of the communication unit 6.

For example, the control unit 10 causes, by executing the browser program 9A, the communication unit 6 to acquire a web page from a web server and one or both of the touch panels 2 and 3 to display the acquired web page thereon. Further, the control unit 10 performs the power saving process such as the control of the touch panels 2 and 3 in accordance with the use status by executing the control program 9G.

The RAM 11 is used as a storage area that temporarily stores the commands of the programs executed by the control unit 10, the data referred to by the control unit 10, the calculation results of the control unit 10, and the like.

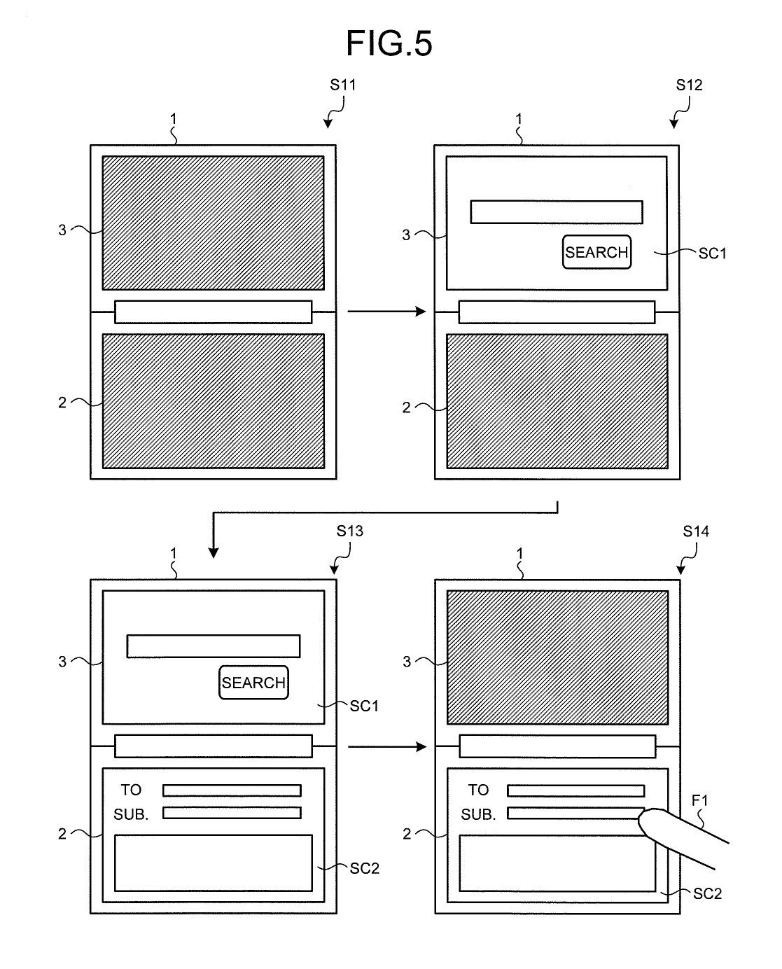

Then, examples of the power saving process performed in accordance with the use status will be described with reference to FIGS. 5 to 9. FIG. 5 is a diagram illustrating an example of the control when two programs separately activated are used. At Step S11 illustrated in FIG. 5, the mobile phone 1 is in the open form. At Step S11, the touch panels 2 and 3 are in a power-saving state, and thus the display of the display units 2B and 3B are stopped. A “power-saving state” refers to a state where the power consumption is less than that in a normal use state.

In this state, it is assumed that a predetermined operation of activating the browser program 9A is detected on the touch panel 3. The predetermined operation is, for example, an operation of touching the touch panel 3 with a finger F1 to resume the display of the display unit 3B and tapping the icon corresponding to the browser program 9A with the finger F1. In this case, the control unit 10 activates the browser program 9A and displays a browser screen SC1 provided by the browser program 9A on the touch panel 3, as illustrated in Step S12.

Subsequently, it is assumed that a predetermined operation of activating the mail program 9B is detected on the touch panel 2. The predetermined operation is, for example, an operation of touching the touch panel 2 with the finger F1 to resume the display of the display unit 2B and tapping the icon corresponding to the mail program 9B with the finger F1. In this case, the control unit 10 activates the mail program 9B and displays a mail composition screen SC2 provided by the mail program 9B on the touch panel 2, as illustrated in Step S13.

Then, it is assumed that the user continues to operate the mail composition screen SC2 with the finger F1 and a period of time in which the operation is not detected on the touch panel 3 displaying the browser screen SC1 exceeds a threshold value. The threshold value may be a value determined in advance or may be a value set by the user. In this case, the browser program 9A corresponding to the browser screen SC1 is permitted to shift to the power-saving state during the execution of the program in the program information 9H; therefore, as illustrated in Step S14, the control unit 10 causes the touch panel 3 to shift to the power-saving state.

At Step S14, the control unit 10 changes the state of the touch panel 3 to the power-saving state by stopping the display of the display unit 3B. Since the display unit 3B is one of the units consuming much power, stopping the display of the display unit 3B contributes greatly to suppressing the power consumption. As in the example of FIG. 5, when the screens provided by the separately activated programs are displayed on the display units, respectively, the user may not experience inconvenience due to no relevance to the respective screens even when the display of one of the display units is stopped.

Further, at Step S14, the control unit 10 suspends the execution of the browser program 9A providing the browser screen SC1. By stopping the execution of the browser program 9A, it is possible to further suppress the power consumption. Since the display of the display unit 3B displaying the browser screen SC1 is stopped, the user may not experience inconvenience even when the execution of the browser program 9A is suspended.

Thereafter, when a touch to the touch panel 3 is detected, the control unit 10 resumes the execution of the browser program 9A and the display of the display unit 3B. Thus, the control unit 10 keeps the function of the touch sensor 3A valid even in the power-saving state. The control unit 10 may also stop the touch sensor 3A in the power-saving state, and resume the execution of the browser program 9A and the display of the display unit 3B when a button provided in the vicinity of the touch panel 3 is pressed down.

In FIG. 5, the case has hitherto been described where the period of time in which an operation is not detected on the touch panel 3 exceeds the threshold value. However, the power saving process is performed likewise even when the period of time in which an operation is not detected on the touch panel 2 displaying the mail composition screen SC2 exceeds the threshold value. That is, when the period of time in which an operation is not detected on the touch panel 2 displaying the mail composition screen SC2 exceeds the threshold value, the control unit 10 stops the display of the display unit 2B and suspends the execution of the mail program 9B.

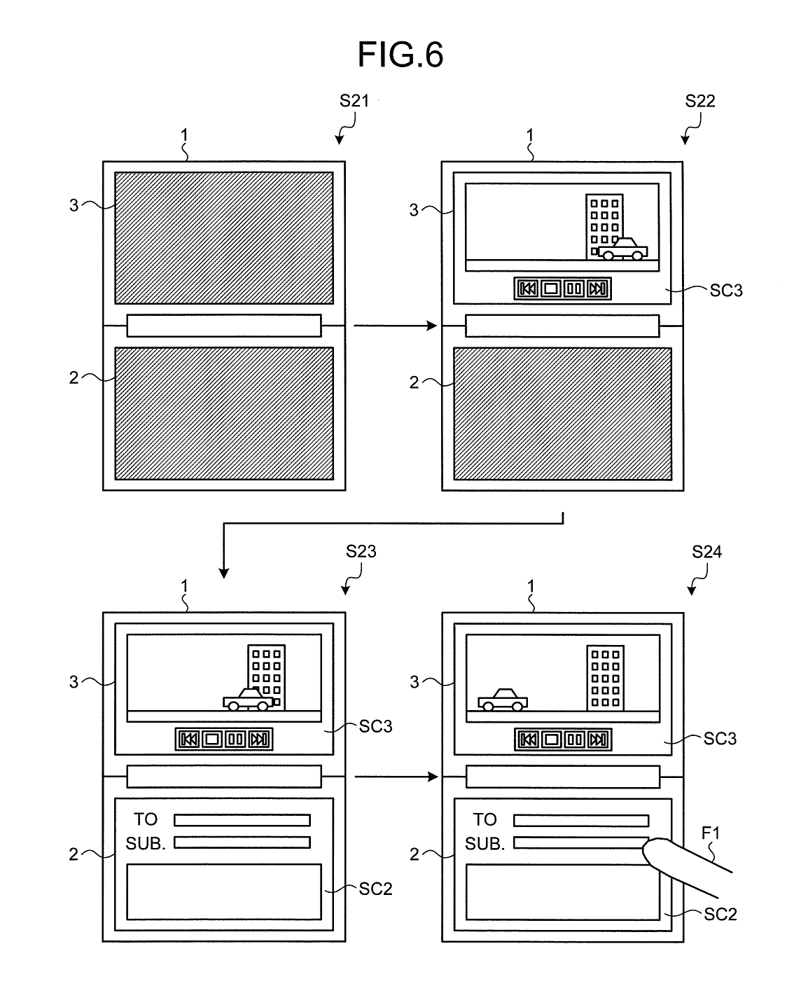

FIG. 6 is a diagram illustrating another example of the control when two programs separately activated are used. At Step S21 illustrated in FIG. 6, the mobile phone 1 is in the open form. At Step S21, the touch panels 2 and 3 are in the power-saving state, and thus the display of the display units 2B and 3B is stopped.

In this state, it is assumed that a predetermined operation of activating the video player program 9C is detected on the touch panel 3. In this case, the control unit 10 activates the video player program 9C and displays a video reproduction screen SC3 provided by the video player program 9C on the touch panel 3, as illustrated in Step S22.

Subsequently, a predetermined operation of activating the mail program 9B is detected on the touch panel 2. In this case, the control unit 10 activated the mail program 9B and displays the mail composition screen SC2 provided by the mail program 9B on the touch panel 2, as illustrated in Step S23.

Then, it is assumed that the user continues to operate the mail composition screen SC2 with the finger F1 and a period of time in which the operation is not detected on the touch panel 3 displaying the video reproduction screen SC3 exceeds the threshold value. In this case, the video player program 9C corresponding to the video reproduction screen SC3 is not permitted to shift to the power-saving state during the execution of the program in the program information 9H; therefore, as illustrated in Step S24, the control unit 10 continues to display the video reproduction screen SC3.

While a video, that is, an image having a motion, or a plurality of images reproduced one after another is displayed on a screen, as the video reproduction screen SC3, the user sometimes views the screen even if an operation to the screen is not detected. Therefore, by continuing to display the video reproduction screen SC3 even when no operation is performed, it is possible to prevent the interruption of the view of the user.

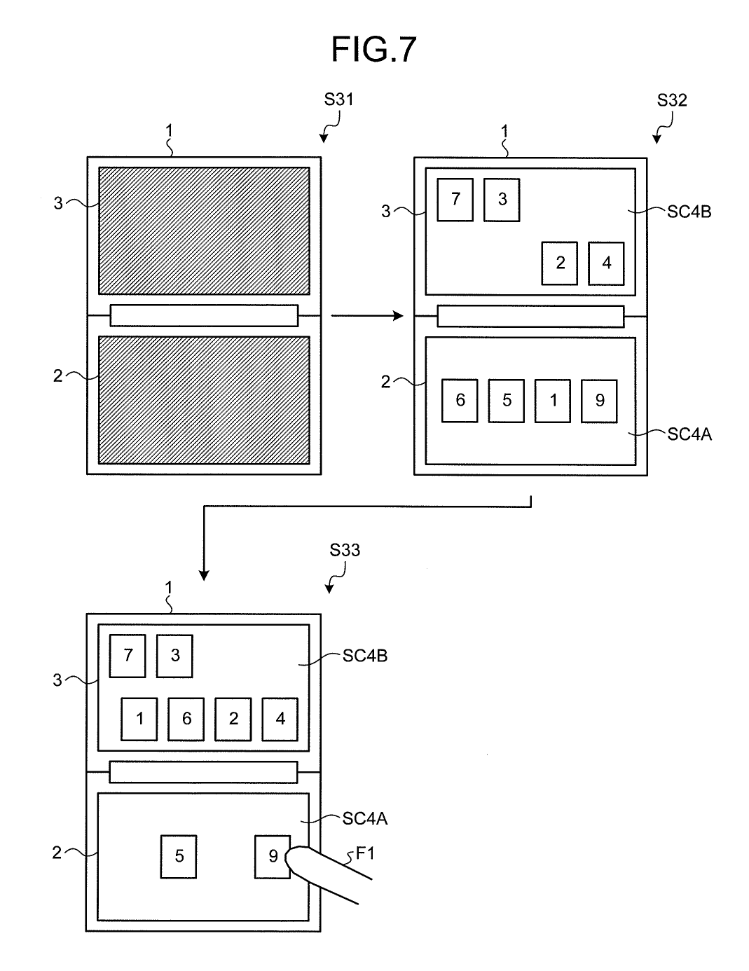

FIG. 7 is a diagram illustrating an example of the control when a two-screen program is used. A “two-screen program” is a program that simultaneously provides screens on the touch panels 2 and 3. On the other hand, a program providing a screen on either one of the touch panel 2 or 3 is referred to as a “one-screen program”. The same program may function as either one of the one-screen program or the two-screen program depending on a state.

At Step S31 illustrated in FIG. 7, the mobile phone 1 is in the open form. At Step S31, the touch panels 2 and 3 are in the power-saving state and the display of the display units 2B and 3B is stopped.

In this state, it is assumed that a predetermined operation of activating the game program 9D is detected on the touch panel 2 or 3. In this case, the control unit 10 activates the game program 9D. As illustrated in Step S32, the control unit 10 displays a game screen SC4A provided by the game program 9D on the touch panel 2 and displays a game screen SC4B provided by the game program 9D on the touch panel 3. The game screen SC4A is an operation screen configured to receive an operation and the game screen SC4B is a result display screen configured to display the result of the operation.

Thereafter, it is assumed that the user continues to operate the game screen SC4A with the finger F1 and a period of time in which the operation is not detected on the touch panel 3 displaying the game screen SC4B exceeds the threshold value. In this case, the game program 9D corresponding to the game screen SC4B is not permitted to shift to the power-saving state during the execution of the program in the program information 9H; therefore, as illustrated in Step S33, the control unit 10 continues to display the game screen SC4B.

As for a screen provided by the two-screen program, the operation screen and the result display screen are associated with each other in some cases. Therefore, when the display of one of the screens provided by the two-screen program is stopped, the user may experience the trouble to use the other screens of the two. By continuing to display the screens provided by the two-screen program even when an operation is not detected on one of them, the trouble can be suppressed.

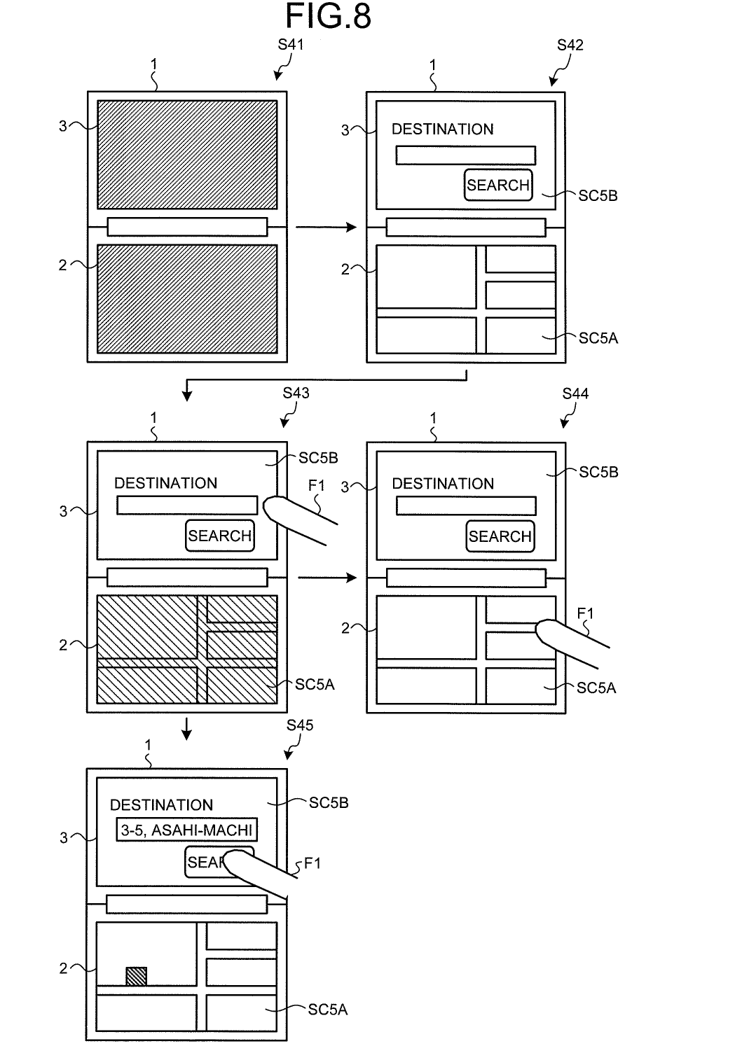

FIG. 8 is a diagram illustrating another example of control when the two-screen program is used. At Step S41 illustrated in FIG. 8, the mobile phone 1 is in the open form. At Step S41, the touch panels 2 and 3 are in the power-saving state and the display of the display units 2B and 3B is stopped.

In this state, it is assumed that a predetermined operation of activating the navigation program 9E is detected on the touch panel 2 or 3. In this case, the control unit 10 activates the navigation program 9E. As illustrated in Step S42, the control unit 10 displays a map display screen SC5A provided by the navigation program 9E on the touch panel 2 and displays a destination search screen SC5B provided by the navigation program 9E on the touch panel 3. The map display screen SC5A is a screen configured to display a map and the destination search screen SC5B is a screen used to search for a destination.

Thereafter, it is assumed that the user continues to operate the destination search screen SC5B with the finger F1 and a period of time in which the operation is not detected on the touch panel 2 displaying the map display screen SC5A exceeds the threshold value. In this case, the navigation program 9E corresponding to the map display screen SC5A is permitted to shift to the power-saving state during the execution of the program in the program information 9H; therefore, as illustrated in Step S43, the control unit 10 changes the state of the touch panel 2 to the power-saving state.

At Step S43, the control unit 10 changes the state of the touch panel 2 to the power-saving state by setting the display of the display unit 2B to a low-lit state. When the display unit 2B is a display device, such as a LCD, including a light source such as a backlight, the low-lit state is realized by stopping the emission of the light source or lowering the brightness of the light source. When the display unit 2B is a self-luminescence type display device such as an OELD, the low-lit state is realized by lowering the luminance.

As illustrated in Step S43, the map display screen SC5A is faintly displayed on the display unit 2B even after the shift to the low-lit state. As described above, the screens provided by the two-screen program are associated with each other in many cases. Therefore, when one of the screens is not viewed, the user may experience a trouble to use the other of the screens. Accordingly, by not stopping the display of the display unit 2B but setting the low-lit state in the power-saving state, it is possible to prevent the inconvenience caused due to not displaying one of the screens while suppressing the power consumption.

When the screens provided by the two-screen program are displayed, the control unit 10 does not stop the execution of the navigation program 9E even after the shift of the touch panel 2 to the power-saving state. Therefore, when the user operates the touch panel 3 which does not shift to the power-saving state, the control unit 10 performs the process corresponding to the operation based on a function provided by the navigation program 9E.

Thereafter, when a touch on the touch panel 2 is detected, the control unit 10 cancels the low-lit state of the display unit 2B and normally displays the map display screen SC5A, as illustrated in Step S44. Further, when the user performs an operation of deciding a destination on the destination search screen SC5B displayed on the touch panel 3, the control unit 10 performs a display process of displaying the destination on the map on the touch panel 2 based on a function provided by the navigation program 9E. At this time, as illustrated in Step S45, the control unit 10 cancels the low-lit state of the display unit 2B and normally displays the map display screen SC5A so that the user can confirm the result of the display process.

In FIG. 8, the case has hitherto been described in which the period of time in which an operation is not detected on the touch panel 2 exceeds the threshold value. However, the power saving process is performed likewise even when a period of time in which an operation is not detected on the touch panel 3 exceeds the threshold value. That is, when the period of time in which an operation is not detected on the touch panel 3 exceeds the threshold value, the control unit 10 changes the state of the display unit 3B to the low-lit state.

When the display unit of one of the touch panels is in the low-lit state as illustrated in Step S43, and a period of time in which an operation is not detected on the other of the touch panels exceeds the threshold value, the control unit 10 changes the states of the touch panels 2 and 3 to the power-saving state. In this case, since it is considered that any screen is not used, the control unit 10 stops the display of the display units 2B and 3B. Further, in this case, the control unit 10 suspends the execution of the two-screen program providing the screens to the touch panels 2 and 3.

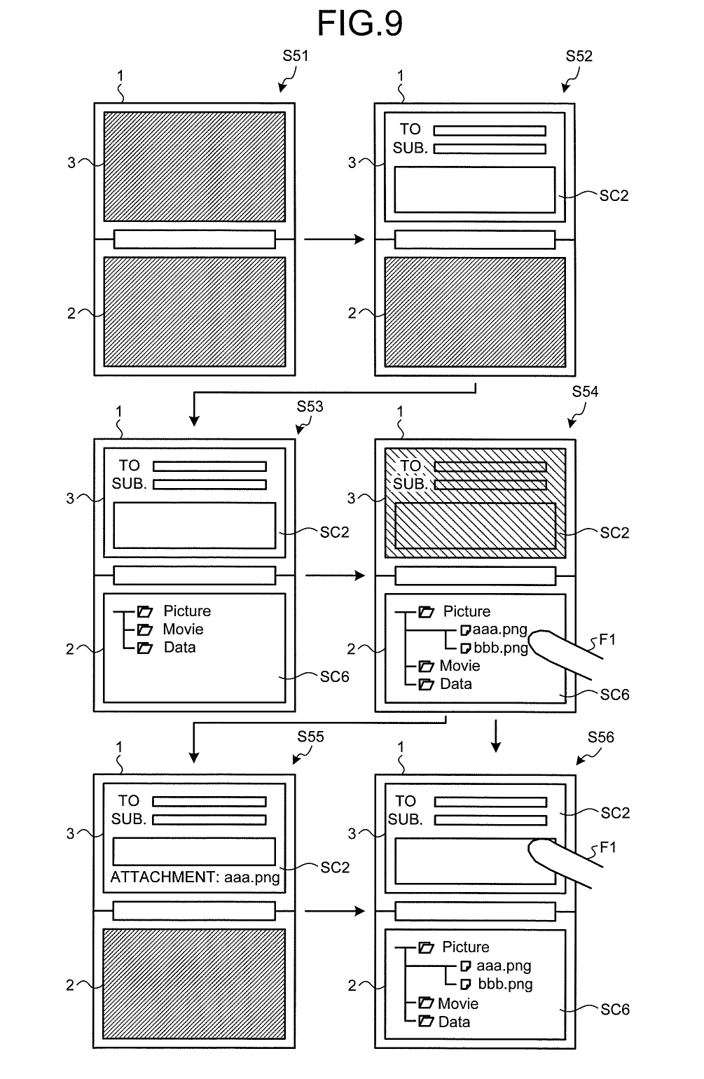

FIG. 9 is a diagram illustrating an example of the control when another program is called from a program. At Step S51 illustrated in FIG. 9, the mobile phone 1 is in the open form. At Step S51, the touch panels 2 and 3 are in the power-saving state and the display of the display units 2B and 3B is stopped.

In this state, it is assumed that a predetermined operation of activating the mail program 9B is detected on the touch panel 3. In this case, the control unit 10 activates the mail program 9B and displays the mail composition screen SC2 provided by the mail program 9B on the touch panel 3, as illustrated in Step S52.

Subsequently, it is assumed that a predetermined operation for selecting a file to be attached to a mail is detected on the touch panel 3. In this case, the control unit 10 activates the filer program 9F by a function provided by the mail program 9B and displays a file selection screen SC6 provided by the filer program 9F on the touch panel 2, as illustrated in Step S53.

Then, it is assumed that the user continues to operate the file selection screen SC6 with the finger F1 and a period of time in which the operation is not detected on the touch panel 3 displaying the mail composition screen SC2 exceeds the threshold value. In this case, the mail program 9B corresponding to the mail composition screen SC2 is permitted to shift to the power-saving state during the execution of the program in the program information 9H; therefore, as illustrated it Step S54, the control unit 10 changes the state of the touch panel 3 to the power-saving state.

At Step S54, the control unit 10 causes the touch panel 3 to shift to the power-saving state by setting the display of the display unit 3B to the low-lit state. In this situation, the filer program 9F called from the mail program 9B is being executed. The screens provided by the programs having a calling relation (dependency relation) are associated with each other in many cases. Therefore, when one of the screens is not displayed, the user may experience the trouble to use the other of the screens. Accordingly, by not stopping the display of the display unit 3B but setting the low-lit state in the power-saving state, it is possible to prevent the inconvenience caused due to not displaying one of the screens while suppressing the power consumption.

Thereafter, it is assumed that the user continues to operate the file selection screen SC6 with the finger F1 to complete the selection of a file. In this case, as illustrated in Step S55, the execution of the filer program 9F provided by the file selection screen SC6 is ended and the file selection screen SC6 is dismissed. When the selection of the file is completed, the control unit 10 performs a returning process from the calling destination to cancel the low-lit state of the display unit 3B and performs a subsequent operation on the mail composition screen SC2. In this case, the control unit 10 reflects the file name of the file selected in the returning process to the mail composition screen SC2.

As illustrated in Step S56, when a touch on the touch panel 3 is detected in the state where the display unit 3B is in the low-lit state, the control unit 10 cancels the low-lit state of the display unit 3B and normally displays the mail composition screen SC2.

In FIG. 9, the case has hitherto been described in which the screen provided by the program called from the program providing the screen to the touch panel 3 is displayed on the touch panel 2, and vice versa. That is, the touch panels 2 and 3 may have a reverse relation.

When the display unit of one of the touch panels is in the low-lit state as illustrated in Step S54, and the period of time in which an operation is not detected on the other of the touch panels exceeds the threshold value, the control unit 10 changes the states of the touch panels 2 and 3 to the power-saving state. In this case, since it is considered that any screen is not used, the control unit 10 may stop the display of the display units 2B and 3B. Further, in this case, the control unit 10 may suspends the execution of the program providing the screen to the touch panel 2 and the execution of the program providing the screen to the touch panel 3.

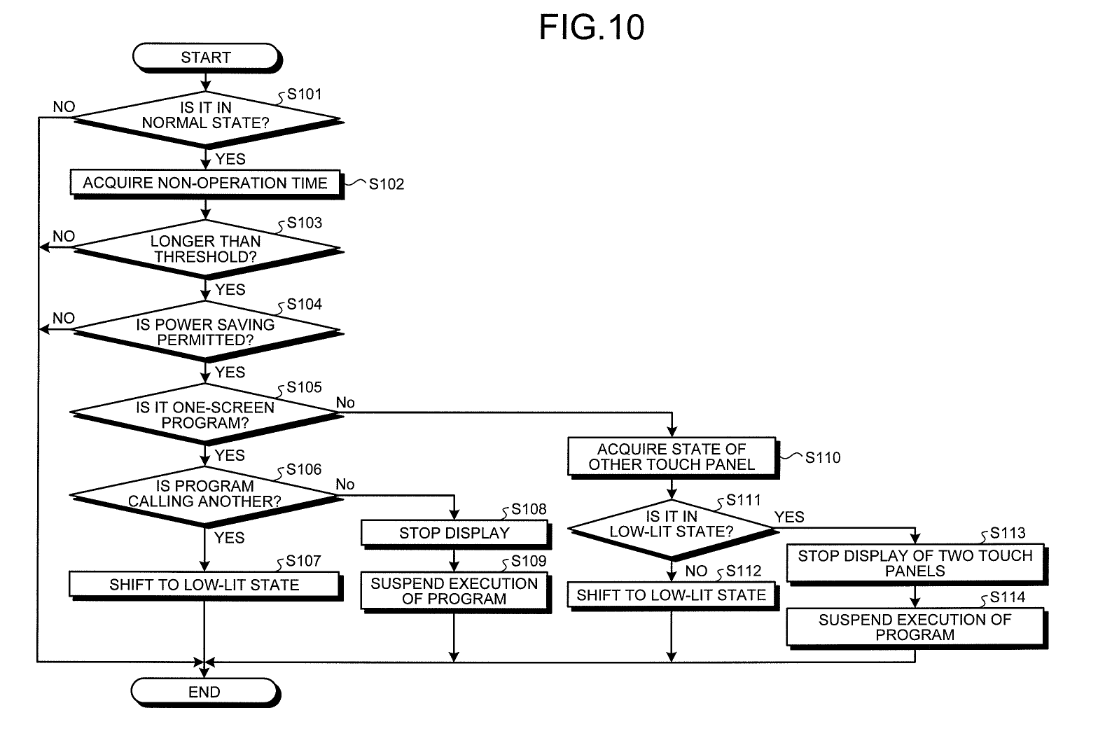

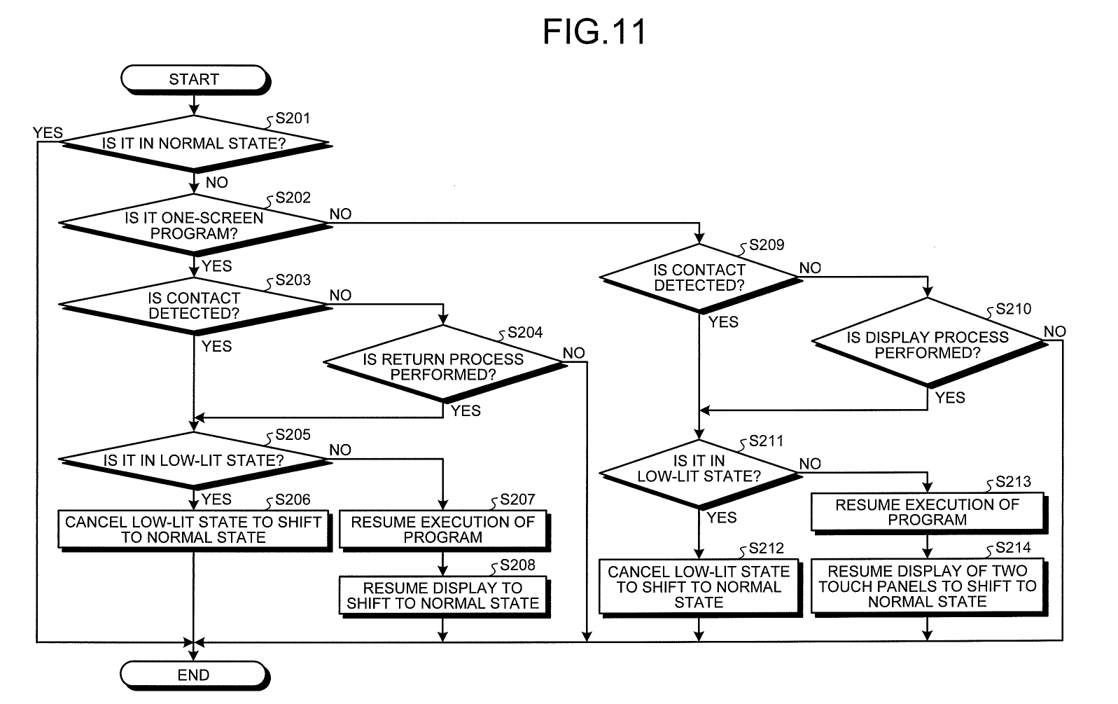

Then, an operation of the mobile phone 1 in the power-saving process will be described with reference to FIGS. 10 and 11. FIG. 10 is a flowchart illustrating a processing sequence of a power-saving proceeding process. The processing sequence illustrated in FIG. 10 is realized by a function provided by the control program 9G and is repeated in each display unit. When the display unit is simply mentioned in the description made in FIG. 10, the simply mentioned display unit represents the display unit which is subject to be processed between the display units 2B and 3B.

As illustrated in FIG. 10, at Step S101, the control unit 10 of the mobile phone 1 determines whether the display unit is in a normal state. When the display unit is not in the normal state, that is, the display unit is already in the power-saving state (No at Step S101), the control unit 10 terminates the power-saving proceeding process.

When the display unit is in the normal state (Yes at Step S101), at Step S102, the control unit 10 acquires a non-operation time which is a period of time in which an operation performed for the display unit is not detected. When the non-operation time is not longer than a threshold value (No at Step S103), the control unit 10 terminates the power-saving proceeding process.

When the non-operation time is longer than the threshold value (Yes at Step S103), at Step S104, the control unit 10 determines whether a program providing a screen to the display unit is permitted to shift to the power-saving state during the execution with reference to the program information 9H. When the shift to the power-saving state during the execution is not permitted (No at Step S104), the control unit 10 terminates the power-saving proceeding process.

When the program providing the screen to the display unit is permitted to shift to the power-saving state during the execution (Yes at Step S104), at Step S105, the control unit 10 determines whether the program is the one-screen program, that is, the program providing the screen only to one of the display units.

When the program providing the screen to the display unit is the one-screen program (Yes at Step S105), at Step S106, the control unit 10 determines whether the program is calling another program. When the program is calling another program (Yes at Step S106), at Step S107, the control unit 10 changes the state of the display unit to the low-lit state. On the other hand, when the program is not calling another program (No at Step S106), the control unit 10 stops the display of the display unit at Step S108, and suspends the execution of the program providing the screen to the display unit at Step S109.

When the program providing the screen to the display unit is not the one-screen program (No at Step S105), at Step S110, the control unit 10 acquires the state of a display unit of the other touch panels. When the display unit of the other touch panels is not in the low-lit state (No at Step S111), at Step S112, the control unit 10 changes the state of the display unit to the low-lit state. On the other hand, the display unit of the other touch panels is in the low-lit state (Yes at Step S111), the control unit 10 stops the display of the display unit at Step S113,and suspends the execution of the program providing the screen to the display unit at Step S114.

FIG. 11 is a flowchart illustrating a processing sequence of a power-saving returning process. The processing sequence illustrated in FIG. 11 is realized by a function provided by the control program 9G and is repeated in each display unit. When the display unit is simply mentioned in the description made in FIG. 11, the simply mentioned display unit represents the display unit to be processed between the display units 2B and 3B.

As illustrated in FIG. 11, at Step S201, the control unit 10 of the mobile phone 1 determines whether the display unit is in a normal state. When the display unit is in the normal state, that is, the display unit is not in the power-saving state (Yes at Step S201), the control unit 10 terminates the power-saving returning process.

When the display unit is not in the normal state, that is, the display unit is in the power-saving state (No at Step S201), at Step S202, the control unit 10 determines whether the program providing the screen to the display unit is the one-screen program.

When the program providing the screen to the display unit is the one-screen program (Yes at Step S202), at Step S203, the control unit 10 determines whether a contact with (a touch on) the display unit is detected. When the contact is not detected (No at Step S203), at Step S204, the control unit 10 determines whether the returning process from the program of the calling destination is performed. When the returning process from the program of the calling destination is not performed (No at Step S204), the control unit 10 terminates the power-saving returning process.

When the contact is detected (Yes at Step S203) or the returning process from the program of the calling destination is performed (Yes at Step S204), at Step S205, the control unit 10 determines whether the display unit is in the low-lit state. When the display unit is in the low-lit state (Yes at Step S205), at Step S206, the control unit 10 cancels the low-lit state of the display unit and changes the state of the display unit to the normal state. When the display unit is not in the low-lit state (No at Step S205), the control unit 10 resumes the execution of the program providing the screen to the display unit at Step S207, and resumes the display of the display unit and changes the state of the display unit to the normal state.

When the program providing the screen to the display unit is not the one-screen program (No at Step S202), at Step S209, the control unit 10 determines whether a contact with the display unit is detected. When the contact is not detected (No at Step S209), at Step S210, the control unit 10 determines whether the display process is performed on the display unit. When the display process is not performed on the display unit (No at Step S210), the control unit 10 terminates the power-saving returning process.

When the contact is detected (Yes at Step S209) or the display process is performed on the display unit (Yes at Step S210), at Step S211, the control unit 10 determines whether the display unit is in the low-lit state. When the display unit is in the low-lit state (Yes at Step S211), at Step S212, the control unit 10 cancels the low-lit state of the display unit to change the state of the display unit to the normal state. When the display unit is not in the low-lit state (No at Step S211), the control unit 10 resumes the execution of the program providing the screen to the display unit at Step S213, and resumes the display of the display units of two touch panels to change the state of the display unit to the normal state at Step S214.

In this embodiment, as described above, the power-saving process is varied depending on a type of program providing the screen and/or a manner of using the display unit. Therefore, it is possible to perform the power saving process suitable for the use state.

The aspects of the invention described in the embodiments can be modified arbitrarily within the range without departing from the gist of the invention. For example, the control program 9G may be divided into a plurality of modules or may be integrated with another program.

In the above-described embodiment, the portable electronic apparatus including the touch sensor as the operation detecting unit has been described. However, the invention is applicable to a portable electronic apparatus including a plurality of physical buttons such as a keyboard as the operation detecting unit.

In the above-described embodiment, whether the shift to the power-saving state during the execution of the program is permitted or not is set in advance in the program information 9H. However, whether the shift to the power-saving state during the execution of the program is performed or not may be determined based on the process of a program. For example, a program providing a screen on which a plurality of images are continuously reproduced, such as the video player program 9C and the game program 9D described above in the embodiment, may be determined as a program forbidden from shifting to the power-saving state during the execution by the portable electronic apparatus. This is because there is a concern that a user may be hindered from viewing the image when the display unit is permitted to shift to the power-saving state during the execution of the program. Examples of the program providing the screen on which a plurality of images is continuously reproduced include a television viewing program and a presentation program.

In the above-described embodiment, the case has hitherto been described in which the execution of the program providing the screen to the display unit is suspended when the state of the display unit is changed to the power-saving state. However, when a unit other than the display unit is controlled based on the program, the program may continue to be executed. For example, when the program providing the screen to the display unit of which the state is changed to the power-saving state is a music reproducing program for reproducing music data, a speaker or the like is controlled based on the music reproducing program to output music being reproduced. In this case, the user can continue to enjoy the music by continuing to execute the music reproducing program even after the state of the display unit is changed to the power-saving state.

In FIGS. 7 and 8, the examples have hitherto been described in which the two-screen program displays different kinds of screens on the plurality of display units. However, when the two-screen program displays one screen over the plurality of display units, the plurality of screens may be processed as one display unit. That is, when one screen is displayed over the plurality of display units and a period of time in which an operation is not detected on any one of the plurality of display units is longer than the threshold value, it may be determined that a non-operation time is longer than the threshold value. Further, when an operation on any one of the plurality of display units is detected at an interval shorter than the threshold value, it may be determined that the non-operation time is shorter than the threshold value. Proceeding and returning to/from the power-saving state may be performed simultaneously in the plurality of display units.

The advantages are that one embodiment of the invention provides a portable electronic apparatus, a control method, and a control program that can realize a power saving process suitably in accordance with the use conditions.

What is claimed is:

1. A portable electronic apparatus comprising:
a first display unit for displaying a first screen;
a first operation detecting unit for detecting an operation for the first screen displayed on the first display unit;
a second display unit for displaying a second screen;
a second operation detecting unit for detecting an operation for the second screen displayed on the second display unit; and
a control unit for performing, when a period of time in which an operation for at least one of the first and second screens is not detected is longer than a threshold value, a power saving process of changing a state of at least one of the first and second display units to a power-saving state in a varied manner depending on a type of program providing the screen for which no operation is detected for a longer period of time than the threshold value.

2. The portable electronic apparatus according to claim 1, wherein
the control unit is configured to perform the power saving process in a varied manner depending on whether the program provides both of the first and second screens or provides one of the first and second screens.

3. The portable electronic apparatus according to claim 2, wherein
the control unit is configured to perform, when the program provides both of the first and second screens, the power saving process in a varied manner depending on whether or not the program provides the first and second screens as one screen displayed over the first and second display units.

4. The portable electronic apparatus according to claim 1, wherein
the control unit is configured not to perform the power saving process when the program executes a process of continuously reproducing a plurality of images.

5. The portable electronic apparatus according to claim 1, wherein
the control unit is configured to perform the power saving process by changing a state of the display unit displaying the screen, for which no operation is detected for a longer period of time than the threshold value, to a low-lit state.

6. The portable electronic apparatus according to claim 5, wherein
the control unit is configured to cancel the low-lit state of the display unit when an operation is detected by the operation detecting unit corresponding to the display unit whose state is changed to the low-lit state among the first and second operation detecting units.

7. The portable electronic apparatus according to claim 1, wherein
the control unit is configured to perform, when the program provides both of the first and second screens, the power saving process by changing a state of the display unit displaying the screen, for which no operation is detected for a longer period of time than the threshold value, to the power-saving state while continuing to execute the program.

8. The portable electronic apparatus according to claim 7, wherein
the control unit is configured to cancel the power-saving state of the display unit when the program provides both of the first and second screens and an operation is detected by the operation detecting unit corresponding to the display unit whose state is changed to the power-saving state among the first and second operation detecting units.

9. The portable electronic apparatus according to claim 7, wherein
the control unit is configured to cancel the power-saving state of the display unit when the program provides both of the first and second screens and causes the control unit to perform a display process for the display unit whose state is changed to the power-saving state after performing the power saving process.

10. The portable electronic apparatus according to claim 7, wherein
the control unit is configured to perform, when the program does not provide both of the first and second screens, the power saving process by suspending the execution of the program and stopping the display of the display unit displaying the screen, for which no operation is detected for a longer period of time than the threshold value, among the first and second display units.

11. A control method executed by a portable electronic apparatus including a first display unit, a second display unit, and an operation detecting unit, the control method comprising:
displaying a first screen on the first display unit;
displaying a second screen on the second display unit;
detecting an operation for a first or second screen by the operation detecting unit;
determining whether a non-operation time in which an operation for at least one of the first and second screens is not detected is longer than a threshold value; and
changing, when the non-operation time is longer than the threshold value, a state of at least one of the first and second display units to a power-saving state in a varied manner depending on a type of a program providing the screen for which the non-operation time is longer than the threshold value.

12. A non-transitory storage medium that stores a control program for causing, when executed by a portable electronic apparatus that includes a first display unit, a second display unit, and an operation detecting unit, the portable electronic apparatus to execute:
displaying a first screen on the first display unit;
displaying a second screen on the second display unit;
detecting an operation for a first or second screen by the operation detecting unit;
determining whether a non-operation time in which an operation for at least one of the first and second screens is not detected is longer than a threshold value; and
changing, when the non-operation time is longer than the threshold value, a state of at least one of the first and second display units to a power-saving state in a varied manner depending on a type of a program providing the screen for which the non-operation time is longer than the threshold value.
